(19) United States
(12) Patent Application Publication
(10) Pub. No.: US 2013/0216647 A1
(43) Pub. Date: Aug. 22, 2013

(54) METHODS FOR MAKING MILK-LIKE BEVERAGES

(71) Applicant: Manjuan Jenny She, Chesterfield, MO (US)

(72) Inventor: Manjuan Jenny She, Chesterfield, MO (US)

(21) Appl. No.: 13/525,963

(22) Filed: Jun. 18, 2012

Related U.S. Application Data
(60) Provisional application No. 61/599,595, filed on Feb. 16, 2012.

(51) Int. Cl. A23C 21/06; A23C 21/04; A23C 21/08; A23C 21/10

(52) U.S. Cl. 426/2; 426/583

(57) ABSTRACT

The invention provides methods for making a milk-like beverage compositions comprising creating a homogeneous aqueous mixture of (1) one or more caseinates, (2) whey protein, (3) one or more fats, (4) one or more hydrocolloids, and (5) one or more emulsifiers; heating the aqueous mixture to a temperature of from about 118 to about 127° C. and maintaining such temperature for from about 8 to about 14 minutes; and cooling the heated aqueous mixture to a temperature of from about 20 to about 35° C. The invention also provides the milk-like beverage compositions made using the methods.

### CROSS REFERENCE TO RELATED APPLICATIONS

This application claims priority to U.S. Provisional Application Ser. No. 61/599,595 filed Feb. 16, 2012, the disclosure of which is incorporated herein by this reference.

### BACKGROUND OF THE INVENTION

1. Field of the Invention

The invention relates generally to beverages and particularly to methods for making milk-like beverages having a milk-like appearance and consistency and to such beverages.

2. Description of Related Art

Many animals consume milk as a part of their regular diet. Although milk alone generally does not fulfill the complete nutritional requirements for an animal, milk provides needed protein, fats, carbohydrate, and other nutrients. Milk may be a substantial part of the diet or may be fed as a supplement or treat.

Although animals, particularly young animals, sometimes consume milk from their own species, most animals consume milk produced by animals from other species, e.g., most animals consume milk from cows, goats, or similar animals, usually cows. Cow milk is often fed to companion animals such as dogs and cats and is consumed in large amounts by humans.

Cow milk is the most widely available and consumed milk. Like most mammalian milk, cow milk contains lactose. Lactose is a sugar that is not completely digested by many animals, including some humans and many animals such as cats and kittens, particularly after they are weaned. This lack of digestion leads to lactose intolerance that is often manifested as digestive discomfort, particularly diarrhea. To avoid these problems, current milk products are treated with the enzyme lactase to hydrolyze the lactose into glucose and galactose. While enzymatic treatment frequently eliminates the problems caused by lactose intolerance, the resulting products tend to develop a brown or otherwise off-white color after the product is heat treated, e.g., in a heat sterilization or pasteurization process. As a result, the product no longer looks like milk; it looks like brown, adulterated milk. While not bound by theory, it is likely that the sugars participate in Maillard reactions that cause the brown or other off-white colors.

Other milk based products reduce the amount of milk in the product by adding water and/or solids to whole or skimmed milk to simulate a milk nutrient profile. These products also often develop an unappealing off-white color. Further, they still contain enough lactose that may result in digestive discomfort for the animal consuming the product, including diarrhea.

Milk analogs and substitutes are known in the art. U.S. Pat. No. 5,792,501 discloses an artificially produced feline milk substitute composition that contains casein, whey, protein, fat, and lactose. U.S. Pat. No. 5,882,714 discloses an artificially produced feline milk substitute composition that contains protein, fat, and carbohydrates. U.S. Pat. No. 5,436,020 discloses formulated human milk analogs in which non-protein nitrogen components are abundant and the lactoglobulin and/or casein are reduced. U.S. Pat. No. 6,245,379 and U.S. Pat. No. 7,404,976 disclose methods for providing nutrition to critical care animals such as dogs and cats by administering an artificially produced canine or feline milk substitute composition containing protein, and carbohydrates. These products, however, do not avoid lactose intolerance while keeping the nutrient profile and appealing appearance of milk. There is, therefore, a need for milk-like beverages that avoid the lactose intolerance caused by milk and milk based products while keeping the nutrient profile and appealing appearance of milk, particularly ones that can be made conveniently using a retort process.

### SUMMARY OF THE INVENTION

It is, therefore, an object of the present invention to provide methods for making milk-like beverages that have a realistic milk-like appearance and consistency.

It is a further object of the present invention to provide milk-like beverages that have a realistic milk-like appearance and consistency.

It is another object of the present invention to provide milk-like beverages that prevent or reduce digestive discomfort caused by lactose intolerance in animals.

It is a further object of the invention to provide milk-like beverages that provide a nutrient profile similar to milk.

It is another object of the invention to provide milk-like beverages that promote the health or wellness of an animal.

One or more of these or other objects are achieved using retort methods for making milk-like beverage compositions comprising from about 1 to about 10% of one or more caseinates, from about 1 to about 10% whey protein, from about 2 to about 10% of one or more fats, from about 0.01 to about 1% one or more hydrocolloids, and from about 0.1 to about 10% one or more emulsifiers. The color of the compositions is very similar, if not identical, to cow milk. Therefore, compared to most known milk-like compositions that are brown or off-white, the essentially white compositions of the present invention have a realistic, milk-like appearance. Similarly, the compositions have the consistency of cow milk. The compositions do not contain lactose and are therefore useful for preventing or reducing digestive discomfort caused by lactose intolerance in animals an animal susceptible to or suffering from lactose intolerance when substituted as a beverage for milk or other lactose containing beverage.

Other and further objects, features, and advantages of the present invention will be readily apparent to those skilled in the art.

### DETAILED DESCRIPTION OF THE INVENTION

### Definitions

The term “animal” means any animal that could benefit from or enjoy the consumption of the milk-like beverage compositions of the present invention, including human, bovine, canine, equine, feline, hicrine, lupine, murine, ovine, or porcine animals.

The term “companion animal” means domesticated animals such as cats, dogs, rabbits, guinea pigs, ferrets, hamsters, mice, gerbils, horses, cows, goats, sheep, donkeys, pigs, and the like.

The term “caseinate” means a compound of casein with a metal such as calcium, sodium, potassium, or magnesium.

The term “whey protein” means the collection of proteins that can be isolated from whey or any protein that functions the same as or similar to whey protein in producing the milk-like beverage of the present invention, including, but are not limited to, soy proteins such as soy protein isolates and wheat proteins such as wheat protein isolates.

The term “health or wellness of an animal” means the complete physical, mental, and social well being of the animal, not merely the absence of disease or infirmity.

All percentages expressed herein are by weight of the total weight of the composition unless expressed otherwise.

All ratios expressed herein are on a weight:weight (w/w) basis unless expressed otherwise.

As used herein, ranges are used herein in shorthand, so as to avoid having to list and describe each and every value within the range. Any appropriate value within the range can be selected, where appropriate, as the upper value, lower value, or the terminus of the range.

As used herein, the singular form of a word includes the plural, and vice versa, unless the context clearly dictates otherwise. Thus, the references “a”, “an”, and “the” are generally inclusive of the plurals of the respective terms. For example, reference to “a milk”, “a method”, or “a food” includes a plurality of such “milks”, “methods”, or “foods.” Similarly, the words “comprise”, “comprises”, and “comprising” are to be interpreted inclusively rather than exclusively. Likewise the terms “include”, “including” and “or” should all be construed to be inclusive, unless such a construction is clearly prohibited from the context. Similarly, the term “examples,” particularly when followed by a listing of terms, is merely exemplary and illustrative and should not be deemed to be exclusive or comprehensive.

The methods and compositions and other advances disclosed here are not limited to particular methodology, protocols, and reagents described herein because, as the skilled artisan will appreciate, they may vary. Further, the terminology used herein is for the purpose of describing particular embodiments only, and is not intended to, and does not, limit the scope of that which is disclosed or claimed.

Unless defined otherwise, all technical and scientific terms, terms of art, and acronyms used herein have the meanings commonly understood by one of ordinary skill in the art in the field(s) of the invention, or in the field(s) where the term is used. Although any compositions, methods, articles of manufacture, or other means or materials similar or equivalent to those described herein can be used in the practice of the present invention, the preferred compositions, methods, articles of manufacture, or other means or materials are described herein.

All patents, patent applications, publications, technical and/or scholarly articles, and other references cited or referred to herein are in their entirety incorporated herein by reference to the extent allowed by law. The discussion of those references is intended merely to summarize the assertions made therein. No admission is made that any such patents, patent applications, publications or references, or any portion thereof, are relevant, material, or prior art. The right to challenge the accuracy and pertinence of any assertion of such patents, patent applications, publications, and other references as relevant, material, or prior art is specifically reserved.

### The Invention

In one aspect, the invention provides milk-like beverage compositions. The compositions comprise from about 1 to about 10% of one or more caseinates, from about 1 to about 10% whey protein, from about 2 to about 10% of one or more fats, from about 0.01 to about 1% one or more hydrocolloids, and from about 0.1 to about 10% one or more emulsifiers.

The compositions have a nutrient profile very similar, if not identical, to cow milk and have a realistic milk-like appearance (white color similar or identical to cow milk) and consistency. Unlike known milk analogs, the compositions do not develop off-white colors, e.g., a brown color, when heated during the manufacturing process. The compositions are useful as food compositions for animals, e.g., companion animals such as cats.

In various embodiments, the milk-like beverage compositions comprise from about 1 to about 10% caseinate, preferably from about 2 to about 8%, most preferably from about 3 to about 6%; from about 1 to about 10% whey protein, preferably from about 2 to about 8%, most preferably from about 3 to about 6%; from about 2 to about 10% fat, preferably from about 3 to about 8%, most preferably from about 4 to about 7%; from about 0.01 to about 1% hydrocolloids, preferably from about 0.1 to about 0.8%, most preferably from about 0.5 to about 5%; and from about 0.1 to about 10% emulsifiers, preferably from about 0.5 to about 8%, most preferably from about 1 to about 6%. Typically, the compositions contain from about 50 to about 95% water.

The caseinates are any suitable caseinates useful to produce the compositions. Preferably, the caseinates are sodium caseinate, calcium caseinate, potassium caseinate, magnesium caseinate, or combinations thereof. Most preferably, the caseinates are sodium caseinate, calcium caseinate, or combinations thereof.

The whey protein is any suitable whey protein useful to produce the compositions. Preferably, the whey protein is a whey protein concentrate, whey protein isolate, whey protein hydrolysate, or combinations thereof. Most preferably, the whey protein is a whey protein isolate.

The fat is any suitable fat useful to produce the compositions. Preferably, the fat is any hydrogenated fat or oil of animal or vegetable origin. In various embodiments, the fat is one or more saturated fats, e.g., saturated fats obtained from dairy products such as cream, cheese, butter, and ghee; animal fats such as suet, tallow, lard, and fatty meat; coconut oil; cottonseed oil; palm oil; and fish oil. In various embodiments, the fats are monounsaturated fats, polyunsaturated fats, or combinations thereof. In some embodiments, the fats are lauric acid, myristic acid, palmitic acid, stearic acid, or combinations thereof. In a preferred embodiment, the fat is anhydrous milk fat.

The hydrocolloids are any suitable hydrocolloids useful to produce the compositions. Preferably, the hydrocolloids are agar, alginate, arabinoxylan, carrageenan, carboxymethylcellulose, cellulose, curdlan, gelatin, gellan, β-glucan, guar gum, gum arabic, locust bean gum, pectin, starch, xanthan gum, or combinations thereof. In one embodiment, the hydrocolloid is k-Carrageenan. In some embodiments, the hydrocolloids are hydrocolloids that will not interact with calcium ions, e.g., gellan gum, xanthan, guar, locust bean gum, or combinations thereof.

The emulsifiers are any suitable emulsifiers useful to produce the compositions. Generally, the emulsifiers are any emulsifier with a hydrophilic-lipophilic balance (HLB) in the range of 3 to 10. Such emulsifiers are capable of maintaining a stable oil in water emulsion. Preferably, the emulsifiers are emulsifiers obtained from vegetable fats (e.g., diacetyl tartaric acid esters of monoglycerides and diglycerides of fatty acids made from edible, fully hydrogenated, vegetable fats sold under the trademark PANODAN®); glycerol; organic acids; or combinations thereof. In certain embodiments, the emulsifiers are distilled monoglycerides such as those under the trademark DIMODAN®. In one embodiment, the emulsifiers are a mixture of diacetyl tartaric (acid) ester of monoglyceride (“DATEM’) and distilled monoglycerides, typically a 50:50 mix. In another embodiment, the emulsifiers are a mixture of lecithin and distilled monoglycerides. In another, the emulsifiers are a mixture of lecithin and monoglycerides or diglycerides or a mixture of DATEM and monoglycerides/diglycerides, all typically in about a 50:50 ratio.

In certain embodiments, the milk-like beverage compositions further comprise one or more palatability enhancers that make the composition more palatable to the animal consuming the composition. Palatability enhancers include, but are not limited to, flavors (e.g., tuna flavor, artificial roast beef flavor), non-reducing sugars such as fructose, pyrophosphates (e.g., sodium acid pyrophosphate), polyphosphates (e.g., sodium tripolyphosphate), or combinations thereof. In one embodiment, particularly when the composition is formulated for felines, the palatability enhancer is tetrasodium pyrophosphate (TSPP). The amount for a particular palatability enhancer will vary depending on the palatability enhancer selected. Selection of such amounts is within the scope of a skilled artisan. Typically, the palatability enhancers are added in amounts of about 0.1 to about 10% of the composition, preferably from about 1 to about 8%, most preferably from about 2 to about 6%. In one embodiment, TSPP is added in amounts of from 3 to about 6%, preferably from about 4 to about 5%.

In certain embodiments, the milk-like beverage compositions further comprise one or more compounds that increase the calcium content of the compositions. Such compounds are added to the composition in amounts required to mimic the calcium content of cow milk or other milk beverage. The amount for such a compound will vary depending on the compound selected. Selection of such compounds and amounts is within the scope of a skilled artisan. For example, in one embodiment, the compositions comprise calcium lactate. In an embodiment, the compositions comprise from about 0.05 to about 1.5% calcium lactate, calcium gluconate, calcium carbonate, calcium chloride, or combinations thereof, preferably from about 0.1 to about 1%, most preferably from about 0.2 to about 0.8%.

In various embodiments, the milk-like beverage compositions further comprise additional ingredients and/or nutrients such as vitamins, minerals, amino acids, nucleic acids, fillers, binding agents, flavors, stabilizers, colorants, buffers, salts, condiments, preservatives, prebiotics, drugs, medicaments, medications, and the like known to skilled artisans. Non-limiting examples of supplementary minerals include phosphorous, potassium, sodium, iron, chloride, boron, copper, zinc, magnesium, manganese, iodine, selenium, and the like. Non-limiting examples of supplementary vitamins include vitamin A, any of the B vitamins, vitamin C, vitamin D, vitamin E, and vitamin K, including various salts, esters, or other derivatives of the foregoing. Additional dietary supplements may also be included, for example, any form of niacin, pantothenic acid, inulin, folic acid, biotin, amino acids, and the like, as well as salts and derivatives thereof. Stabilizers include substances that tend to increase the shelf life of the composition such as preservatives, synergists and sequestrants, packaging gases, thickeners, gelling agents, and humectants. Selection of the ingredients and their amounts is known to skilled artisans. Such ingredients must be selected carefully, i.e., the ingredient and/or amount of the ingredient must be adjusted so that the ingredient does not cause the color of the milk-like beverage of the present invention. Specific amounts for each additional ingredient will depend on a variety of factors such as the ingredient included in the composition; the species of animal; the animal's age, body weight, general health, sex, and diet; the animal's consumption rate; the purpose for which the food compositions is being administered to the animal; and the like. Therefore, the component and ingredient amounts may vary widely and may deviate from the preferred proportions described herein.

In various embodiments, the milk-like beverage compositions further comprise one or more of vitamin E, taurine, vitamin D, or combinations thereof. In one embodiment, the compositions comprise from about 0.1 to about 5% vitamin E, preferably from about 0.5 to about 4%, most preferably from about 1 to about 3%. In another embodiment, the compositions comprise from about 0.01 to about 0.5% taurine, preferably from about 0.02 to about 0.4%, most preferably from about 0.03 to about 0.3%.

In various embodiments, the milk-like beverage compositions further comprise (1) one or more killed or inactivated probiotics that promote health benefits similar to or the same as the live probiotics, (2) components of the killed or inactivated probiotics that promote health benefits similar to or the same as the live probiotics, or (3) combinations thereof. The killed or inactivated probiotics or their components can be integrated into the beverages, e.g., uniformly or non-uniformly distributed in the composition. In one embodiment, the killed or inactivated probiotics or their components are encapsulated in a carrier. Typical probiotics from which killed or inactivated probiotics or their components are derived include, but are not limited to, probiotic strains selected from Lactobacilli, Bifidobacteria, or Enterococci, e.g., Lactobacillus reuteii, Lactobacillus acidophilus, Lactobacillus animalis, Lactobacillus ruminis, Lactobacillus johnsonii, Lactobacillus casei, Lactobacillus paracasei, Lactobacillus rhamnosus, Lactobacillus fermentum, and Bifidobacterium sp., Enterococcus faecium and Enterococcus sp. In some embodiments, the probiotic strain is selected from the group consisting of Lactobacillus reuteri (NCC2581; CNCM 1-2448), Lactobacillus reuteri (NCC2592; CNCM 1-2450), Lactobacillus rhamnosus (NCC2583; CNCM 1-2449), Lactobacillus reuteri (NCC2603; CNCM 1-2451), Lactobacillus reuteri (NCC2613; CNCM 1-2452), Lactobacillus acidophilus (NCC2628; CNCM 1-2453), Bifidobacterium adolescentis (e.g., NCC2627), Bifidobacterium sp. NCC2657 or Enterococcus faecium SF68 (NCIMB 10415). The beverages contain killed or inactivated probiotics or their components in amounts sufficient to supply the equivalent of from about 10⁴ to about 10¹² cfu/animal/day, preferably from 10⁵ to about 10¹¹ cfu/animal/day, most preferably from 10⁷ to 10¹⁰ cfu/animal/day base on the equivalent to live microorganisms. Many such probiotics and their benefits are known to skilled artisans, e.g., EP1213970B1, EP1143806B1, U.S. Pat. No. 7,189,390, EP1482811B1, EP1296565B1, and U.S. Pat. No. 6,929,793.

In various embodiments, the milk-like beverage compositions further comprise one or more prebiotics, e.g., fructo-oligosaccharides, gluco-oligosaccharides, galacto-oligosaccharides, isomalto-oligosaccharides, xylo-oligosaccharides, soybean oligosaccharides, lactosucrose, lactulose, and isomaltulose. In one embodiment, the prebiotic is chicory root, chicory root extract, aleurone, inulin, or combinations thereof. Generally, prebiotics are administered in amounts sufficient to positively stimulate the healthy microflora in the gut. Typical amounts are from about 1 to about 10 grams per serving or from about 5 to about 40% of the recommended daily dietary fiber for an animal.

The milk-like beverages are suitable for any animal that normally consumes milk, either from the animal's own species or milk from another species. In particular, the milk-like beverages are suitable for consumption by animals that consume cow milk, including humans, canines, and felines. In a preferred embodiment, the milk-like beverages are suitable for use as a feline milk substitute. In these embodiments, the beverages are formulated by skilled artisans for various animals depending on their species, health, age, size, nutrient requirements, and the like.

In another aspect, the invention provides methods for making milk-like beverage compositions. The methods comprise creating a homogeneous aqueous mixture of (1) one or more caseinates in amounts sufficient to produce a final composition containing from about 1 to about 10% caseinates, (2) whey protein in amounts sufficient to produce a final composition containing from about 1 to about 10% whey protein, (3) one or more fats in amounts sufficient to produce a final composition containing from about 2 to about 10% of one or more fats, (4) one or more hydrocolloids in amounts sufficient to produce a final composition containing from about 0.01 to about 1% of one or more hydrocolloids, and (5) one or more emulsifiers in amounts sufficient to produce a final composition containing from about 0.1 to about 10% of one or more emulsifiers; heating the aqueous mixture to a temperature of from about 118 to about 127° C., preferably from about 120 to about 125° C., most preferably from about 120° C., and maintaining such temperature for from about 8 to about 14 minutes, preferably from about 10 to about 12 minutes; and cooling the heated aqueous mixture to a temperature of from about 20 to about 35° C.

The methods produce milk-like beverage compositions that have a nutritional profile similar or identical to cow milk and have a realistic, milk-like appearance and consistency. In particular, the compositions have the same color as or a color very similar to the color of cow milk, i.e., the compositions are white like cow milk. In contrast, prior art milk-like compositions with similar nutrient profiles are off-white or brown.

The homogeneous aqueous mixture is created using any suitable means known to skilled artisans. In preferred embodiments, the mixture is created by adding the components to any suitable container while stirring. The order of additions is not critical. Generally, the dry components are added to water with stirring and then the non-dry components are added to the mixture with stirring. The components can be heated, cooled, and pressurized (or depressurized) using any suitable method known to skilled artisans. Generally, the components are heated, cooled, and pressurized in a heat exchanger or an extruder. Preferably, the components are heated, cooled, and pressurized in a heat exchanger.

In one embodiment, water, preferably purified water, is preheated to a temperature of from about 60 to about 70° C. Then, one or more caseinates in amounts sufficient to produce a final composition containing from about 1 to about 10% caseinates and whey protein in amounts sufficient to produce a final composition containing from about 1 to about 10% whey protein are added to the heated water and mixed until a homogeneous mixture of water, caseinates, and whey protein is obtained. Generally, the components are mixed by stirring at a speed of from about 600 to about 800 rpm for a period of from about 10 to about 20 minutes. The caseinates and whey protein are added at a rate that eliminates clumps in the composition.

Subsequently, one or more emulsifiers in amounts sufficient to produce a final composition containing from about 1 to about 10% are added to the mixture and mixed until a homogeneous mixture is obtained. Generally, mixing the components at from about 600 to about 700 rpm for a period of from about 1 to about 5 minutes is sufficient to produce the homogeneous mixture.

Then, one or more hydrocolloids in amounts sufficient to produce a final composition containing from about 0.01 to about 1% are added to the mixture and mixed until a homogeneous mixture is obtained. Generally, mixing the components at from about 600 to about 700 rpm for a period of from about 1 to about 5 minutes is sufficient to produce the homogeneous mixture.

The hydrocolloids are added in a single step or can be added in two or more steps. In some embodiments, the hydrocolloids are added in two or more steps. In such embodiments, the some hydrocolloids are added and the mixture is stirred at about 600 to about 700 rpm for a period of from about 2 to about 4 minutes and then more hydrocolloids are added and the mixture is stirred at about 600 to about 700 rpm for a period of from about 2 to about 4 additional minutes. More than one step may be required based upon the physical and chemical properties of the ingredients selected to produce the compositions.

Also, at these stages, dry ingredients such as k-carrageenan and optional palatability enhancers such as TSPP, vitamins, minerals, calcium enhancers such as calcium lactate, and any other dry ingredients can be added to the mixture with stirring. Further, non-dry ingredients such as emulsifier oils, palatability enhancers, vitamins such as vitamin E, minerals, and any other non-dry ingredients can be added to the mixture with stirring.

Then, one or more fats in amounts sufficient to produce a final composition containing from about 2 to about 10% fat are added to this mixture and mixed until a homogeneous mixture containing the fat is obtained. Generally, the fat is added to the mixture with stirring and stirred at from about 600 to about 700 rpm for a period of from about 5 to about 15 minutes, e.g., about 10 minutes. The resulting aqueous mixture is heated to a temperature of from about 118 to about 127° C. and maintained at such temperature for from about 8 to about 14 minutes. Then, the mixture is cooled to a temperature of from about 20 to about 35° C. The resulting milk-like beverage compositions can be used immediately or can be stored pending packaging or further use or consumption.

In another aspect, the invention provides milk-like beverage compositions made according to the methods of the invention.

WO2010114627 discloses milk-like beverages having the same or similar ingredients but made using ultra high temperature (UHT) processes instead of the retort processes of the present invention.

In another aspect, the invention provides methods for preventing or reducing digestive discomfort caused by lactose intolerance in animals. The methods comprise administering to an animal susceptible to or suffering from lactose intolerance, as a substitute for milk or other beverage containing lactose, a milk-like beverage made according to the methods of present invention. Generally, the compositions comprise from about 1 to about 10% of one or more caseinates, from about 1 to about 10% whey protein, from about 2 to about 10% of one or more fats, from about 0.01 to about 1% one or more hydrocolloids, and from about 0.1 to about 10% one or more emulsifiers. The beverage has the appearance and consistency of cow milk and is therefore palatable to the animal. However, the beverage does not contain lactose and therefore does not cause symptoms associated with lactose intolerance, e.g., bloating, pain, cramps, gurgling sounds, rumbling sounds, gas, loose stools, foamy stools, vomiting, or diarrhea.

In another aspect, the invention provides methods for promoting the health or wellness of animals. The methods comprise administering to an animal, as a substitute for milk, a milk-like beverage made according to the methods of present invention. Generally, the beverages comprise from about 1 to about 10% of one or more caseinates, from about 1 to about 10% whey protein, from about 2 to about 10% of one or more fats, from about 0.01 to about 1% one or more hydrocolloids, and from about 0.1 to about 10% one or more emulsifiers. The methods are particularly useful for promoting the health or wellness of lactose intolerant animals and animals that need the nutrition provided by milk but cannot consume milk or do not have milk available for consumption. In one embodiment, the methods comprise administering the milk-like beverage to an animal susceptible to or suffering from lactose intolerance as a substitute for milk or other beverage containing lactose. In another, the methods comprise administering to an animal a milk-like beverage that has been formulated as described herein to contain one or more nutrients that are beneficial to the animal, e.g., vitamins and minerals.

The milk-like beverages can be administered to the animal using any suitable means. Preferably, the beverages are administered orally, e.g., by feeding the beverage to the animal. The amount of the beverage to be administered to an animal depends on the purpose of the administration, the animal, the animal's health, the animal's age, and the like. Such amounts can be determined by a skilled artisan. Typically, for preventing or reducing digestive discomfort caused by lactose intolerance, the amount of the beverage administered is based on the amount of milk recommended for an animal. Similarly, for providing nutrients to animals that do not or cannot consume milk, the amount of the beverage administered is based on the amount of milk recommended for an animal but can be adjusted based upon the amount of nutrients in the beverage formulation.

In another aspect, the invention provides packages comprising a material suitable for containing a milk-like beverage made according to the methods of present invention. Generally, the beverage comprises from about 1 to about 10% of one or more caseinates, from about 1 to about 10% whey protein, from about 2 to about 10% of one or more fats, from about 0.01 to about 1% one or more hydrocolloids, and from about 0.1 to about 10% one or more emulsifiers and a label affixed to the package containing a word or words, picture, design, acronym, slogan, phrase, or other device, or combination thereof, that indicates that the contents of the package contains the milk-like beverage. In various embodiments, the package further comprises a word or words, picture, design, acronym, slogan, phrase, or other device, or combination thereof, that indicates that the milk-like beverage has one or more of (1) an appealing milk-like color or texture, (2) a nutrient profile that is the same as or similar to cow milk, (3) a lactose free formulation, (4) a formulation that is useful for preventing or reducing digestive discomfort caused by lactose intolerance.

Typically, such device comprises the words “milk substitute” or “formulated to mimic natural milk” or “lactose free” or “avoids digestive discomfort” or an equivalent expression printed on the package. Any package or packaging material suitable for containing the milk-like beverage of the present invention is useful in the invention, e.g., a bag, box, bottle, can, pouch, and the like manufactured from paper, plastic, foil, metal, and the like. In a preferred embodiment, the package contains a milk-like beverage of the present invention, preferably a milk-like beverage prepared for felines.

In a further aspect, the invention provides a means for communicating information about or instructions for one or more of (1) using milk-like beverage compositions made according to the methods of present invention for preventing or reducing digestive discomfort caused by lactose intolerance; (2) using the compositions as a substitute for milk, particularly to provide nutrients to animals that do not or cannot consume milk; and (3) administering the compositions to an animal. The means comprises a document, digital storage media, optical storage media, audio presentation, or visual display containing the information or instructions. In certain embodiments, the communication means is a displayed web site, visual display kiosk, brochure, product label, package insert, advertisement, handout, public announcement, audiotape, videotape, DVD, CD-ROM, computer readable chip, computer readable card, computer readable disk, computer memory, or combination thereof containing such information or instructions. Useful information includes one or more of (1) methods and techniques for administering the compositions and (2) contact information for animals or their caregivers to use if they have a question about the invention and its use. Useful instructions include administration amounts and frequency. The communication means is useful for instructing on the benefits of using the present invention.

### EXAMPLES

The invention can be further illustrated by the following examples, although it will be understood that these examples are included merely for purposes of illustration and are not intended to limit the scope of the invention unless otherwise specifically indicated.

### Example 1

The formulation shown in Table 1 was used to produce a milk-like beverage composition. 896 kg of purified water was heated to about 30° C. in a Breddo Liquefier. 20.8 kg of whey protein isolate was added to the heated water with agitation at 680 rpm and blended for 1 minute. Then the solution was heated to 70° C. 35 kg of milk fat anhydrous and 3.8 kg of emulsifiers (mono and diglycerides) were then poured into the mixture blended for 2 minutes. 36.6 kg sodium caseinate was then slowly added to the heated water in the Breddo liquefier with agitation at 680 rpm to avoid forming clumps, blending continued for 12 minutes. The remaining dry ingredients (4.5 kg of TSPP, 1.3 kg of gellan gum, and 1.6 kg of vitamin & mineral premix) were then added to the mixture in the liquefier and blended for a further 5 more minutes. The product was pumped into a two-stage (2500/500 PSI) homogenizer where, in the first stage, the beverage was subjected to 2500 psi and, in the second stage, the pressure was reduced to 500 psi. The homogenized product was then filled into a packaging (can or bottle) suitable for retorting process. The packaging was retorted at a temperature of about 121° C. Target heating factor Fₒ was 5. Cooking time was 8-14 minutes. The packaging was then cooled down to room temperature. Such packaging was ready for distribution and/or use.

TABLE 1

| % | Kg |
|---|---|
| Water | 896.4 |
| Sodium Caseinate | 36.6 |
| Whey Protein Isolate | 20.8 |
| Tetrasodium Pyrophosphate (TSPP) | 4.5 |
| Gellan Gum | 1.3 |
| Milk Fat Anhydrous | 35 |
| Monoglycerides | 1.9 |
| Diacetyl Tartaric Acid Esters of Mono and Diglycerides | 1.9 |
| Vitamin & Mineral Premix | 1.6 |

In the specification, there have been disclosed typical preferred embodiments of the invention. Although specific terms are employed, they are used in a generic and descriptive sense only and not for purposes of limitation. The scope of the invention is set forth in the claims. Obviously many modifications and variations of the invention are possible in light of the above teachings. It is therefore to be understood that within the scope of the appended claims, the invention may be practiced otherwise than as specifically described.

1. A method for making a milk-like beverage composition comprising creating a homogeneous aqueous mixture of (1) one or more caseinates in amounts sufficient to produce a final composition containing from about 1 to about 10% caseinates, (2) whey protein in amounts sufficient to produce a final composition containing from about 1 to about 10% whey protein, (3) one or more fats in amounts sufficient to produce a final composition containing from about 2 to about 10% of one or more fats, (4) one or more hydrocolloids in amounts sufficient to produce a final composition containing from about 0.01 to about 1% of one or more hydrocolloids, and (5) one or more emulsifiers in amounts sufficient to produce a final composition containing from about 0.1 to about 10% of one or more emulsifiers; heating the aqueous mixture to a temperature of from about 118 to about 127° C. and maintaining such temperature for from about 8 to about 14 minutes; and cooling the heated aqueous mixture to a temperature of from about 20 to about 35° C.

2. (canceled)

3. The method of claim 1, wherein the caseinates are sodium caseinate, calcium caseinate, potassium caseinate, magnesium caseinate, or combinations thereof.

4. The method of claim 1, wherein the caseinates are sodium caseinate, calcium caseinate, or combinations thereof.

5. The method of claim 1, wherein the whey protein is whey protein concentrate, whey protein isolate, whey protein hydrolysate, or combinations thereof.

6. The method of claim 1, wherein the whey protein is whey protein isolate.

7. The method of claim 1, wherein the fats are hydrogenated fats or oils of animal or vegetable origin or combinations thereof.

8. The method of claim 1, wherein the fats are monounsaturated fats, polyunsaturated fats, or combinations thereof.

9. The method of claim 1, wherein the fats are lauric acid, myristic acid, palmitic acid, stearic acid, or combinations thereof.

10. The method of claim 1, wherein the fat is anhydrous milk fat.

11. The method of claim 1, wherein the hydrocolloids are agar, alginate, arabinoxylan, carrageenan, carboxymethylcellulose, cellulose, curdlan, gelatin, gellan, β-glucan, guar gum, gum arabic, locust bean gum, pectin, starch, xanthan gum, or combinations thereof.

12. The method of claim 1, wherein the emulsifiers are any emulsifier with a hydrophilic-lipophilic balance (HLB) in the range of 3 to 10.

13. The method of claim 1, wherein the emulsifiers are diacetyl tartaric acid esters of monoglycerides and diglycerides of fatty acids made from edible, fully hydrogenated, vegetable fats, glycerol; organic acids; or combinations thereof.

14. The method of claim 1, wherein the emulsifiers are a mixture of lecithin and distilled monoglycerides.

15. The method of claim 14, wherein the mixture is about 50% lecithin and 50% distilled monoglycerides

16. The method of claim 1, wherein the emulsifiers are a mixture of diacetyl tartaric (acid) ester of monoglyceride and distilled monoglycerides.

17. The method of claim 16, wherein the mixture is about 50% ester of monoglyceride and 50% distilled monoglycerides.

18. The method of claim 1, further comprising one or more palatability enhancers.

19. The method of claim 18, wherein the palatability enhancer is tetrasodium pyrophosphate.

20. (canceled)
